(19) United States
(12) Patent Application Publication
(10) Pub. No.: US 2026/0247383 A1
(43) Pub. Date: Aug. 20, 2026

(54) BUFFER INDICATION SIGNALING FOR SEAMLESS ROAMING

(71) Applicant: Cisco Technology, Inc., San Jose, CA (US)

(72) Inventors: Binita Gupta, San Diego, CA (US); Brian D. Hart, Sunnyvale, CA (US)

(73) Assignee: Cisco Technology, Inc., San Jose, CA (US)

(21) Appl. No.: 19/543,312

(22) Filed: Feb. 18, 2026

Related U.S. Application Data
(60) Provisional application No. 63/759,898, filed on Feb. 18, 2025.

(51) Int. Cl. H04W 72/20; H04W 28/02; H04W 72/21

(52) U.S. Cl. CPC H04W 72/20; H04W 28/0278; H04W 72/21

(57) ABSTRACT

Buffer indication signaling during seamless roaming may be provided. A serving access point (AP) establishes one or more links with a client device, wherein the client device is configured to roam from the serving AP to a target AP. The serving AP transmits buffered downlink (DL) data to the client device during a roaming transition from the serving AP to the target AP. The serving AP determines that the buffered DL data for the client device has been transmitted to the client device and transmits to the client device buffer indication signaling indicating that the serving AP has delivered the buffered DL data for the client device.

### RELATED APPLICATION

Under provisions of 35 U.S.C. § 119(e), Applicant claims the benefit of and priority to U.S. Provisional Application No. 63/759,898, filed Feb. 18, 2025, the disclosure of which is incorporated herein by reference in its entirety.

### TECHNICAL FIELD

The present disclosure relates generally to providing buffer indication signaling during seamless roaming.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for Access Point (AP) buffer indication signaling for seamless roaming in accordance with aspects of the present disclosure.

FIG. 2 illustrates a seamless roaming process in accordance with aspects of the present disclosure.

FIG. 3 is a message exchange diagram illustrating a procedure for AP buffer indication signaling for seamless roaming in accordance with aspects of the present disclosure.

FIG. 4 is a block diagram of an example quality of service (QoS) data frame in accordance with aspects of the present disclosure.

FIG. 5 is a block diagram of another example QoS data frame in accordance with aspects of the present disclosure.

FIG. 6 is a block diagram of a buffer status report (BSR) control field in accordance with aspects of the present disclosure.

FIG. 7 is a block diagram of an ultra high reliability (UHR) link reconfiguration notify frame in accordance with aspects of the present disclosure.

FIG. 8 is a flow diagram illustrating a method for serving AP buffer indication signaling for seamless roaming in accordance with aspects of the present disclosure.

FIG. 9 is a block diagram of a computing device in accordance with aspects of the present disclosure.

FIG. 10 is a block diagram of a communications device in accordance with aspects of the present disclosure.

### DETAILED DESCRIPTION

### Overview

Buffer indication signaling during seamless roaming may be provided. A serving access point (AP) establishes one or more links with a client device, wherein the client device is configured to roam from the serving AP to a target AP. The serving AP transmits buffered downlink (DL) data to the client device during a roaming transition from the serving AP to the target AP. The serving AP determines that the buffered DL data for the client device has been transmitted to the client device and transmits to the client device buffer indication signaling indicating that the serving AP has delivered the buffered DL data for the client device.

Both the foregoing overview and the following example embodiments are examples and explanatory only and should not be considered to restrict the disclosure's scope, as described, and claimed. Furthermore, features and/or variations may be provided in addition to those described. For example, embodiments of the disclosure may be directed to various feature combinations and sub-combinations described in the example embodiments.

### EXAMPLE EMBODIMENTS

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Roaming in Wi-Fi networks occurs when a client device (e.g., a Station (STA), a non-Access Point Multi-Link Device (non-AP MLD)) transitions its connection from one Access Point (AP) (e.g., an AP MLD) to another AP, typically because the client device has moved outside the range of its current AP or has identified another AP that can provide a better connection. Roaming decisions are primarily made by client devices based on Received Signal Strength Indicator (RSSI) measurements, supplemented by network recommendations from the serving AP regarding suitable neighbor APs.

Seamless roaming techniques have been developed to reduce roaming latency and improve user experience during AP transitions. Non-Multi-Link Device (MLD) seamless roaming techniques include those described in IEEE 802.11k, which reduce the time required to roam by enabling a client to more quickly determine which AP it should roam to next, with the current AP providing information regarding neighboring APs and their channels. Another non-MLD technique is described in IEEE 802.11r, which uses Fast Basic Service Set (BSS) Transition (FT) to allow encryption keys to be stored on all of the APs in a network, enabling a client device to avoid performing the complete authentication process to a backend server every time it roams to a new AP within the network, thus reducing authentication-related latency.

MLD-based seamless roaming as defined in the IEEE 802.11bn amendment introduces Seamless Mobility Domains (SMDs), which are logical, secure groupings of multiple AP MLDs that enable client devices to roam between them without disconnecting, re-authenticating, re-associating, or experiencing packet loss. MLD-based seamless roaming enables a “make-before-break” approach where a device establishes a connection to a new AP MLD before releasing the old one by utilizing multiple links. The IEEE 802.11bn seamless roaming procedures include a roaming preparation phase during which the client device and serving AP exchange signaling to prepare one or more target APs for the upcoming roaming transition, followed by a roaming execution (or roaming transition) phase during which the actual transition to the target AP occurs. The roaming preparation phase may include negotiation of target APs, establishment of security associations with target APs, and preparation of link configurations, enabling the subsequent roaming execution to occur with minimal latency and data loss.

To achieve lossless roaming performance, IEEE 802.11bn defines a downlink (DL) data draining mode wherein the client device can fetch buffered DL data from the current serving AP MLD even after it has started roaming execution/transition with a target AP MLD. This capability enables the serving AP to deliver buffered DL data to the client to minimize or avoid data loss during the roaming transition. This mode is particularly important for client devices with a single radio that can only be actively connected to one AP at a time, as such devices must choose between retrieving buffered data from the serving AP and establishing data exchanges with the target AP.

However, existing seamless roaming mechanisms lack any means for the client device to determine whether there is buffered DL data remaining on the serving AP or how much buffered DL data remains. The client device needs to know when there is no buffered DL data left on the serving AP so the client device can fully transition to the target AP and initiate uplink (UL) and DL transmissions with the target AP. Some implementations utilize a data delivery timeout value (also referred to as a data drain timeout or DL data drain timeout) that defines a period for retrieving buffered data before initiating data exchanges with the target AP. However, this timeout may be configured as a worst-case value (e.g., several seconds) to ensure sufficient time for data retrieval under poor channel conditions, even though actual buffered data delivery may complete much sooner (e.g., within tens of milliseconds). As a result, this timeout period may not be short enough to prevent unnecessary delays between receiving the buffered data from the serving AP and initiating data exchanges with the target AP. Without knowledge of the actual buffer status at the serving AP, a client device must either wait for the full timeout period (causing unnecessary delay) or risk transitioning to the target AP prematurely (potentially causing data loss).

The present disclosure describes buffer indication signaling mechanisms that enable the client device to determine when the serving AP has delivered all or substantially all of its queued data for the client. With the described buffer indication signaling, the client device is able to transition to exchanging data with the target AP at the optimal time. For instance, the client neither waits unnecessarily for a conservative timeout to expire nor transitions prematurely before all buffered data has been retrieved. In various embodiments, the serving AP may signal buffer status information using existing frame structures and fields, newly defined fields within management frames, or combinations thereof, enabling the client device to make informed decisions about when to complete its transition to the target AP based on actual DL data buffer conditions rather than conservative timeout values. These buffer indication signaling mechanisms improve roaming transition times, reduce latency, reduce data loss, and enhance overall user experience during seamless roaming operations.

In certain embodiments, the buffer indication signaling comprises signaling a zero or empty buffer indication to the client device. Thus, the signaling indicates to the client device that DL data buffers are empty at the serving AP. In some implementations, the serving AP may make the determination to signal empty buffer indication when substantial amount of buffered DL data is delivered to the client device. As referred herein, the buffer indication signaling primarily refers to the embodiment where the signaling comprises the zero or empty buffer indication. However, the buffer indication signaling may also or instead indicate that a threshold amount of buffered DL data, comprise delete link signaling, and so on in various embodiments described herein.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or,” “and/or,” “at least one of,” and “one or both of” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

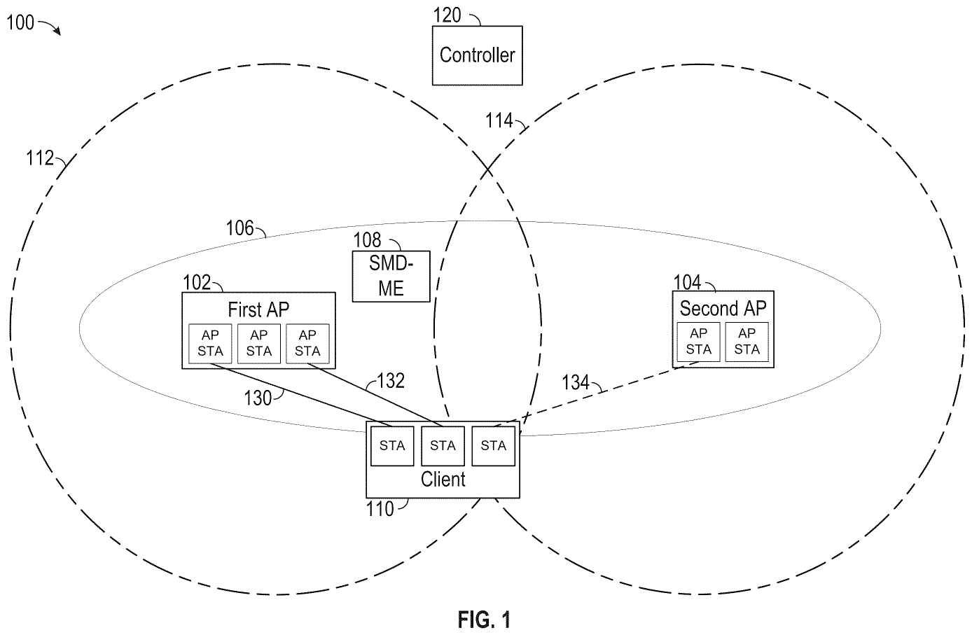

FIG. 1 is a block diagram of an operating environment 100 for AP buffer indication signaling for seamless roaming. In the illustrated embodiment, the operating environment 100 includes a first AP 102, a second AP 104, a client device 110, and a controller 120. The first AP 102 has a service area or cell indicated by the first cell 112, and the second AP 104 has a service area indicated by the second cell 114. The range of the first AP 102 and the second AP 104 may extend past the boundaries of the associated cells, resulting in overlapping coverage, but the signals grow weaker as devices move away from the respective APs. Thus, the first AP 102 and the second AP 104 may fail to communicate reliably with devices some distance past the edges of the associated cells. The edges of the first cell 112 and the second cell 114 as shown in the operating environment 100 are examples and may be different in other implementations (e.g., different sizes, shapes, etc.).

The APs in the operating environment 100 are grouped into one or more seamless mobility domains (SMDs), such as the SMD 106 in the illustrated embodiment. The SMD 106 provides seamless roaming to clients across AP MLDs within the SMD 106. A client device 110 associates at the SMD level with an SMD-Management Entity (ME) within the SMD 106 and then roam between AP MLDs within the SMD without performing reauthentication or reassociation, to achieve seamless roaming. The first AP 102 and second AP 104 are part of the same SMD 106.

The client device 110 is any device that connects to the network to communicate with other devices on the network, such as a smartphone, a tablet, a personal computer, a laptop, an Internet of Things (IoT) device, and/or the like. As illustrated in FIG. 1, the client device 110 is currently associated with the SMD 106 (e.g., via the SMD-ME 108), within the first cell 112, and connected with the first AP 102. However, the client device 110 may be moving toward the boundary of the first cell 112 and into the second cell 114, indicating that the client device 110 may soon need to roam from the first AP 102 to the second AP 104 or another neighbor AP to maintain network connectivity and quality of service (QoS).

An AP, such as the first AP 102 and the second AP 104, is generally a fixed station that communicates with client devices and may also be referred to as a base station, wireless device, or some other terminology. The APs may support seamless roaming procedures (e.g., as defined in the IEEE 802.11bn amendment), including roaming preparation and roaming execution (or roaming transition) phases, that enable the client device 110 to transition between APs (e.g., AP MLDs) within the same SMD 106 with reduced roaming latency and data loss. In some embodiments, the first AP 102 and the second AP 104 are in a same SMD, enabling seamless roaming between them without the client device 110 needing to disconnect, re-authenticate, re-associate, or experience packet loss.

The controller 120 may be any network controller (e.g., a WLAN controller) and may manage the first AP 102, the second AP 104, the SMD 106, the SMD-ME 108, and/or other network devices (not shown) to allow wireless devices such as the client device 110 to connect to the network. In some embodiments, the operations of the controller 120 described herein may be performed by one or more of the first AP 102, the second AP 104, and/or another device, and vice versa. In some embodiments, for example, the controller 120 is included within or integrated with an AP and coordinates the links formed by that AP. In some embodiments, the controller 120 is separate from the APs and coordinates the links of multiple APs. The operating environment 100 is an example configuration and there may be a different number of clients, APs, controllers, and/or other devices in further examples.

As used herein, an AP along with the client devices associated with the AP (e.g., the client devices within the coverage area or cell of the AP) may be referred to as a basic service set (BSS). In the illustrated example, the first AP 102 is the serving AP for the client device 110 within the first cell 112. The APs may communicate with one or more client devices on the DL and UL. The DL is the communication link from an AP to a client device 110, and the UL is the communication link from a client device 110 to an AP. In some cases, a client device 110 may also communicate peer-to-peer with another client device.

As shown in FIG. 1, the client device 110 and the APs are MLDs and each include one or more STAs. The client device 110 uses the STAs to form links with the AP STAs. For example, the client device 110 may use a first STA to form a first wireless link 130 with a corresponding STA of the first AP 102, and the client device 110 may use a second STA to form a second wireless link 132 with another STA of the first AP 102. Each STA may include Physical (PHY)-layer and lower-Media Access Control (MAC) components. The MLDs may also include an upper-MAC for coordinating the multiple STAs (or links) that are part of the MLD. The STAs can use different frequency bands for various wireless links. For example, the first wireless link may be formed using a 5 GHz band and the second wireless link may be formed using a 6 GHz band. Note, however, that these are merely example frequency bands and that the wireless links may use any suitable frequency bands, including 2.4 GHz, 5 GHz, 6 GHz, or other bands.

In general, the AP(s) and the client device 110 may form any suitable number of links for communication using any suitable frequencies. In some instances, the client device 110 may form links with one AP (e.g., the first link 130 and the second link 132 with the first AP 102). In other instances, the client device 110 may form links with multiple APs (e.g., the first link 130 and the second link 132 with the first AP 102 and a third link 134 with the second AP 104). As a result, the client device 110 may communicate with one or more APs over multiple links using different frequencies. Additionally, setup links may not always be active or otherwise useable. For example, the third link 134 may be setup with the second AP 104 as part of roaming preparation, but the roaming execution may not have occurred yet. After roaming execution to the second AP 104, the third link 134 can be used.

The controller 120 may provide coordination and control for the APs. For example, the controller 120 may handle adjustments to radio frequency power, channels, authentication, association, and security for the APs. The controller 120 may also coordinate the links formed by the client device(s) 110 with the APs. For example, the controller 120 may coordinate when the client device 110 and an AP communicate over a link using a particular frequency, the type of data communicated over a particular link, when the client device 110 and the AP form or terminate certain links, and/or when the client device 110 and AP (pre)-associate with each other to (pre)-establish certain links.

The client device 110 may be referred to as a STA MLD or non-AP MLD (e.g., a STA or client device acting as an MLD) and the first AP 102 or second AP 104 may be referred to as an AP MLD (e.g., an AP that acts as an MLD). The STA MLD and AP MLD are generally representative of any device capable of performing multi-link (ML) operations. An MLD may generally be classified based on whether it is a single radio MLD or multi-radio MLD. Single radio MLDs generally use a single radio (e.g., STA) to switch between one or more links. One category of single radio MLDs is Enhanced Multi-Link Single Radio (eMLSR). eMLSR devices generally operate one main wireless radio that can transmit and/or receive data frames on a given link, but can listen in low capability on a set of links when the device is not actively transmitting or receiving. Multi-radio MLDs may generally be classified into the following two types: (i) simultaneous transmission and reception (STR) MLD and (ii) non-STR MLD. For STR MLDs, a transmission on one link does not affect the operations of frame reception and clear channel assessment (CCA) on other links. Stated differently, for STR MLDs, individual links can operate independently of each other. For non-STR MLDs, the operation on one link may be restricted by the operation on another link. For example, a transmission on one link may not be allowed if it will cause reception interruption on another link, or a reception or CCA on one link may not be allowed if a transmission is ongoing on another link.

In certain embodiments, the operating environment 100 may enable the client device 110 to utilize seamless roaming techniques such as roaming without performing re-association with one or more APs, receiving neighbor reports to determine a target AP, and so on. In certain embodiments, as the client device 110 moves away from the coverage of an AP, the client device 110 may perform roaming preparation procedures to add links with a target AP MLD as it roams in the coverage of target APs within the SMD 106 to continue connectivity with the network. In certain embodiments, the beacons' signal strength (e.g., RSSIs) from APs in the client device 110 roaming path acts as triggers for initiating roaming preparation to add links with target AP MLD(s).

During seamless roaming from the first AP 102 (serving AP) to the second AP 104 (target AP), the client device 110 can continue to receive buffered DL data from the first AP 102 even after roaming execution with the second AP 104 has commenced, enabling lossless roaming performance. However, determining when to complete the transition to the target AP presents challenges, particularly for single-radio MLDs that can only actively connect to one AP at a time and must choose between retrieving buffered DL data from the serving AP and exchanging data with the target AP. Without knowledge of the buffer status at the first AP 102, the client device 110 must rely on a data delivery timeout (also referred to as a data drain timeout or DL data drain timeout), which is typically configured as a worst-case value (e.g., several seconds) to ensure sufficient time for data retrieval under poor channel conditions, even though actual buffered data delivery may complete much sooner (e.g., within tens of milliseconds). This timeout approach results in either unnecessary delays (if the client waits for the full timeout when no buffered data remains) or potential data loss (if the client transitions prematurely before all buffered data has been retrieved).

To address this problem, the first AP 102 can send to the client device 110 buffer indication signaling to indicate when the first AP 102 has delivered all or substantially all of its queued data for the client device 110. Using the buffer indication signaling, the client device 110 is able to transition to exchanging data with the second AP 104 at the optimal time, neither waiting unnecessarily for a conservative timeout to expire nor transitioning prematurely, and can then remove links with the first AP 102, thereby achieving faster roaming transition times and improved overall performance.

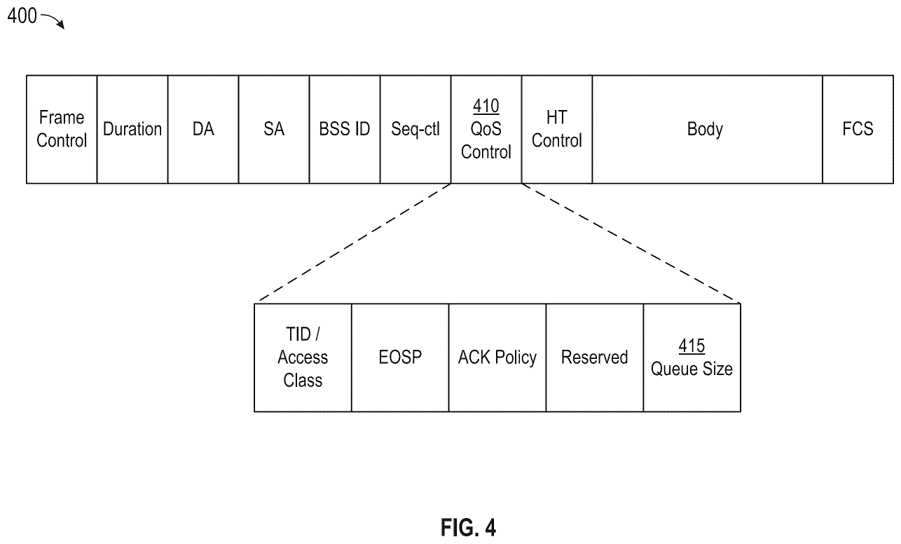

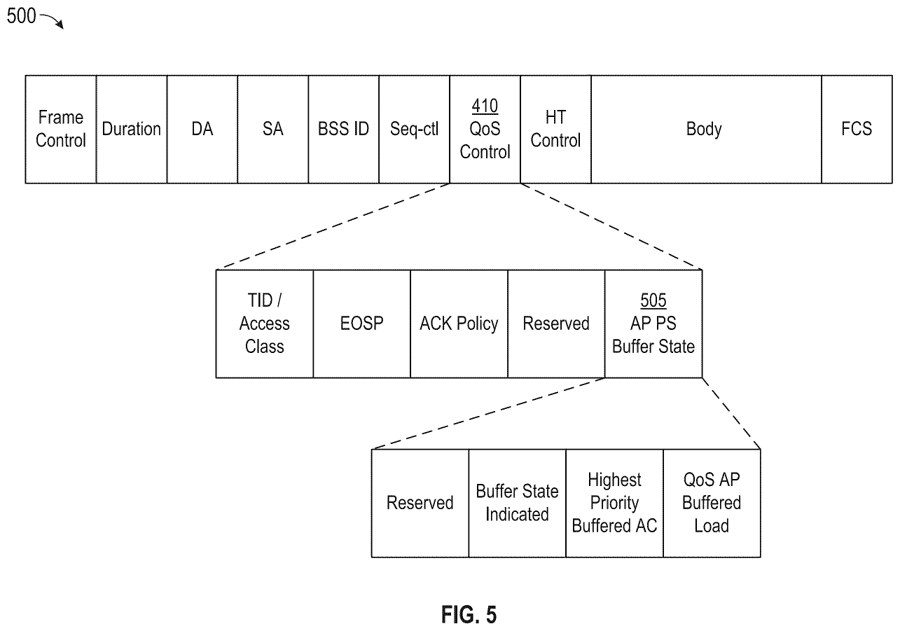

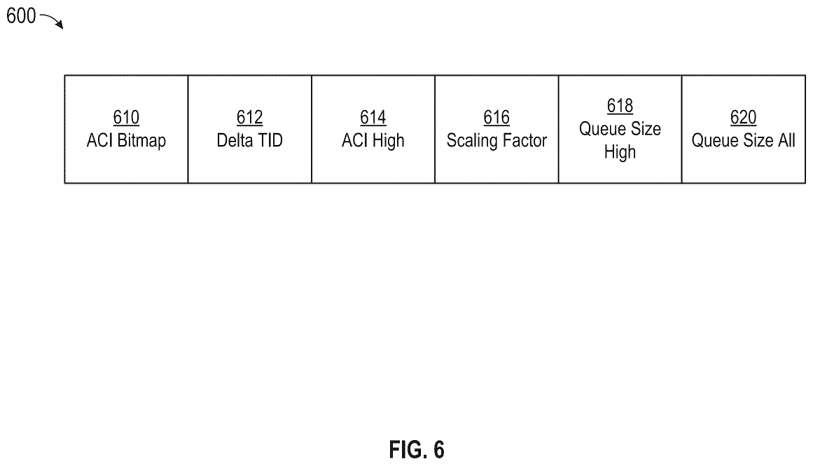

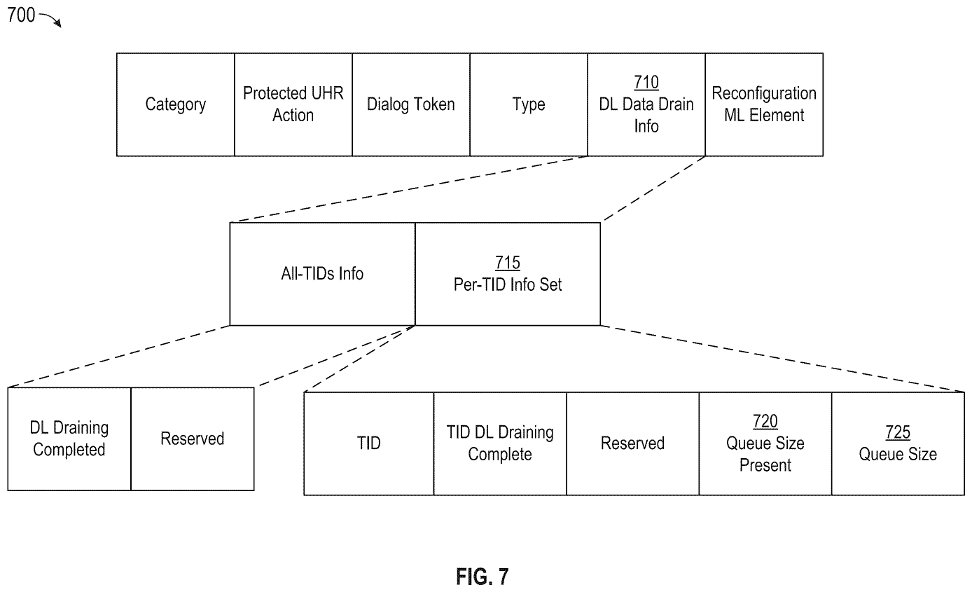

In certain embodiments, the serving AP (e.g., the first AP 102) provides buffer indication signaling by sending an explicit indication that DL data buffers are empty or deliver of buffered DL data is otherwise complete to the client device 110 on one of the active links. For example, the serving AP MLD signals empty buffer indication on one of the links where it was delivering the buffered DL data. Multiple approaches may be used to signal zero buffered DL data remaining to the client device 110 during a roaming transition. As will be described in further detail herein with respect to FIGS. 4-5, the explicit indication can be provided via a quality of service (QoS) data frame, such as using a Queue Size field or an AP PS Buffer State field in the QoS Control field of the MAC header. As will be described in further detail herein with respect to FIG. 6, the explicit indication can be provided via a buffer status report (BSR) control field of a DL MAC Protocol Data Unit (MPDU). In one embodiment, the explicit indication can be provided in a management frame (e.g., a Link Reconfiguration Notify frame as shown in FIG. 7) indicating that the serving AP is done with delivery of buffered DL data. This indication in the management frame can be provided on a per Traffic Identifier (TID) basis as for embodiments above, indicating for which TIDs the serving AP has completed delivery of buffered DL data

In implementations where the empty buffer state changes (e.g., long-delayed MAC Service Data Units (MSDUs) reach the serving AP from the network after the serving AP has sent the empty buffer indication to the client device 110), the serving AP may (i) silently attempt to forward the new MSDUs to the target AP (e.g., the second AP 104) without disclosing their existence to the client device 110 and/or (ii) attempt to transmit an updated buffer indication to the client. For example, the serving AP can transmit the signaling similar to when it indicates that zero buffered data remains but instead indicate non-empty buffers. If the client is in a power save mode (e.g., Power Management (PM)=1), the serving AP may indicate via the traffic indication map (TIM) element that the serving AP has buffered traffic for the client device 110.

In some embodiments, the serving AP provides buffer indication signaling by sending explicit delete links for the set of links with the serving AP. When the serving AP MLD has completed delivery of all (or a threshold amount that is substantially all) buffered DL data (e.g., across TIDs/ACs), the serving AP can send a management frame to signal deletion of links for the client, which signals that the serving AP is done with delivery of buffered DL data. The management frame signaling deletion of links may be sent as soon as possible to minimize or eliminate the amount of time the client device 110 waits unnecessarily for receiving DL buffered data from the serving AP when there is no buffered data left. As will be described in detail with respect to FIG. 7, the serving AP can send delete link signaling via an ultra high reliability (UHR) link reconfiguration notify frame. The serving AP can also use a link reconfiguration request frame, a BSS transition management (BTM) request frame, or other management frame for delete link signaling. The delete link signaling can serve the purpose of deleting the links with the serving AP and also indicating that the serving AP is done with delivery of buffered DL data.

In example implementations, the deletion of client links with the serving AP is triggered and performed by the serving AP itself (instead of the client device 110) to optimize the process and reduce overhead. In further implementations, the serving AP sends a Link Reconfiguration Notify frame, a BTM Request frame, or another management frame with a specific reason code or field indicating that the serving AP is done with delivery of buffered DL data (i.e., providing an empty DL buffer indication to the client device). This indication of the empty DL buffer may result in the client device 110 deleting the links with the serving AP MLD (e.g., using Link Reconfiguration Request/Response frames or locally deleting links without an explicit exchange with the serving AP). The serving AP may assume that the links for the client device 110 are deleted after sending a frame with buffer indication signaling.

Because the serving AP may be unable to continue sending data to the client device 110 once the links are deleted, the serving AP might perform zero buffer indication signaling initially and then perform the delete link signaling (e.g., after the serving AP has a high confidence level, such as over 95% certain, that no new data will appear). Thus, the serving AP accounts for the possibility of long-delayed data (e.g., MSDUs) reaching the serving AP from the network after the serving AP has sent the delete link indication to the client device. However, the serving AP may be able to forward the data to the target AP in certain embodiments. If the serving AP is able to forward the new data to the target AP, the serving AP may not require initially sending zero buffer indications before signaling to delete the links.

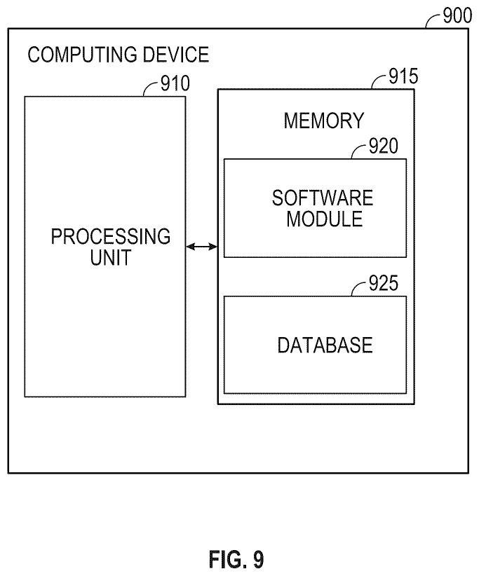

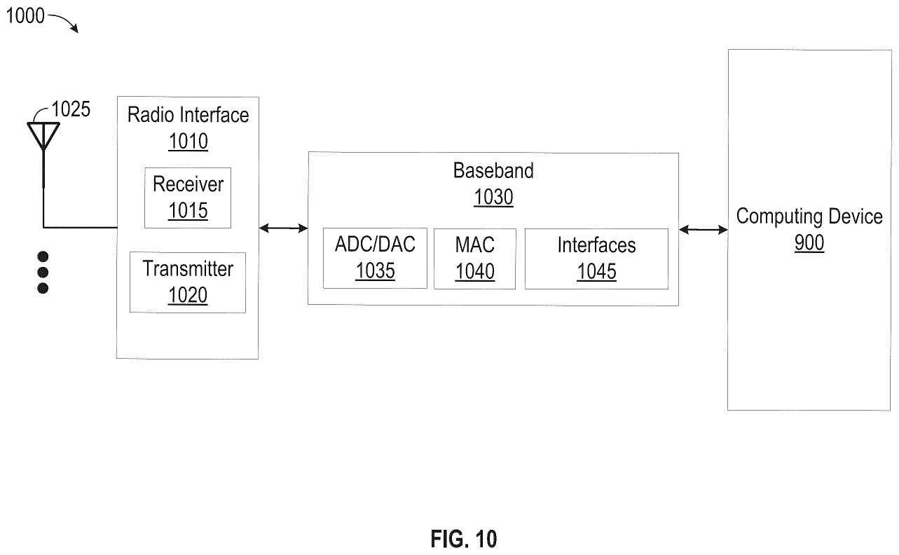

The elements described above of the operating environment 100 (e.g., the first AP 102, the second AP 104, the SMD-ME 108, the client device 110, the controller 120, etc.) may be practiced in hardware, in software (including firmware, resident software, micro-code, etc.), in a combination of hardware and software, or in any other circuits or systems. The elements of the operating environment 100 may be practiced in electrical circuits comprising discrete electronic elements, packaged or integrated electronic chips containing logic gates (e.g., Application Specific Integrated Circuits (ASIC), Field Programmable Gate Arrays (FPGA), System-On-Chip (SOC), etc.), a circuit utilizing a microprocessor, or on a single chip containing electronic elements or microprocessors. Furthermore, the elements of the operating environment 100 may also be practiced using other technologies capable of performing logical operations such as, for example, AND, OR, and NOT, including but not limited to, mechanical, optical, fluidic, and quantum technologies. As described in greater detail below with respect to FIGS. 9 and 10, the elements of the operating environment 100 may be practiced in a computing device 900 and/or communications device 1000.

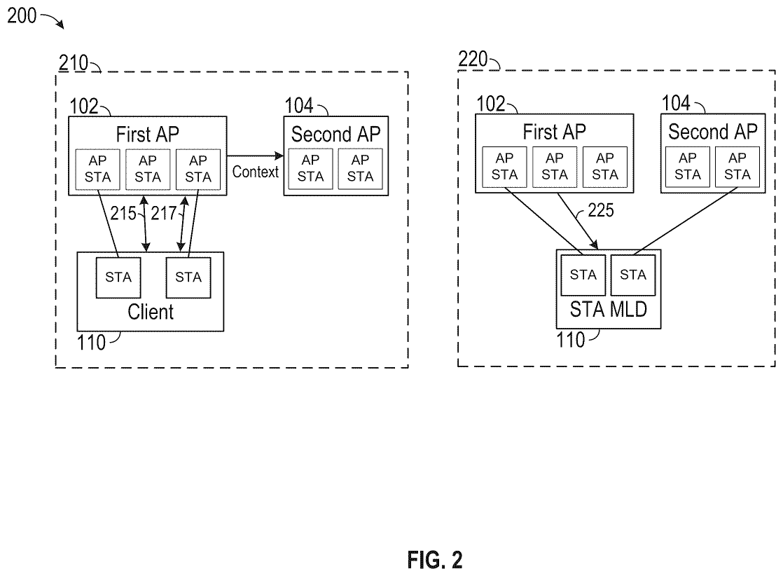

FIG. 2 illustrates an example seamless roaming process 200 with the client device 110 roaming from the first AP 102 (serving AP) to the second AP 104 (target AP) (e.g., within the SMD 106). The seamless roaming process includes a roaming preparation procedure and roaming execution procedure. The roaming preparation procedure involves coordination between serving AP MLD and one or more target AP MLDs, to add one or more links at the target AP MLD(s) and reserve resources at the target APM MLD(s) (such as stream classification service (SCS) and Block Acknowledge resources). After roaming preparation is complete, the client device 110 then performs roaming execution to complete its roaming transition. The two phases of roaming procedure minimize connection disruption during roaming and provides faster and more seamless roaming.

Roaming preparation and execution is shown in phase 210. During the phase 210, the client device 110 and the first AP 102 perform an SMD BSS transition (ST) preparation exchange 215. The ST preparation exchange 215 includes an ST preparation request sent from the client device 110 to the first AP 102, indicating that the client device 110 intends to roam to one or more target APs and requests to prepare or add links on those target APs. In response to the ST preparation request, the first AP 102 sends context related to the client device 110 to the second AP 104 and potentially other target APs indicated in the request or identified by the first AP 102. The context transferred may include link setup information, parameters related to block acknowledgement agreements setup for the client device 110, SCS streams setup for the client device 110, mirrored SCS (MSCS) streams setup for the client device 110, target wake time (TWT) agreements setup for the client device 110, TID-to-link mapping (TTLM) agreements setup for the client device 110, security association context associated with the client device 110, capabilities of the client device 110, and/or other context information.

The ST preparation exchange 215 further includes an ST preparation response sent from the first AP 102 to the client device 110 indicating whether the roaming preparation request succeeds, for example indicating whether one or more target APs accepted the roaming preparation request and indicate the set of links that were added on the target AP. If at least one target AP (the second AP 104 in the illustrated embodiment) accepts the roaming request and has setup one or more links for the client device 110, the preparation procedure in phase 210 is considered successful. The ST preparation exchange 215 can further include additional ST requests, context transfers, and ST responses if the roaming request fails or to provide multiple options to the client device 110. The roaming preparation procedure can include any operations described in various IEEE 802.11 specifications and amendments, including the IEEE 802.11bn amendment.

Following successful completion of the ST preparation exchange 215, the first AP 102 and the client device 110 can perform a roaming execution procedure to enable the client device 110 to transition to the second AP 104. Roaming execution involves client device 110 performing an ST execution exchange 217 with the first AP 102. The ST execution exchange 217 completes the roaming execution to the second AP 104. In some embodiments, the roaming execution exchange can also be performed directly with the target AP (not shown in FIG. 2). In this case, the buffered DL data delivery is not allowed if the roaming execution is performed directly with the target AP. and the serving AP does not provide an empty buffer indication to the client device 110 in certain embodiments. In other implementations, the buffered DL data delivery is still allowed if the roaming execution is performed directly with the target AP MLD, and the serving AP can provide buffer indication signaling to the client device 110.

After roaming execution is completed, the client device 110 enters a roaming transition phase 220. In the roaming transition phase 220, the client device 110 has established at least one link with the second AP 104 (the target AP) and may maintain at least one link with the first AP 102, for example to perform download of buffered DL data at the first AP 102. During this phase, although the client device 110 has established links with the second AP 104, the second AP 104 still needs to be signaled when those links can be used for DL and triggered UL transmissions since the client device may not be ready to use those links yet. In one embodiment, during the roaming transition phase 220, the client device may be connected to only one AP at a time (e.g., a single radio client device). Also, a single radio client device 110 may perform sequential operation with the first AP 102 and the second AP 104, where the client device 110 first performs download of any buffered DL data from the first AP 102 and then fully transitions all its links to the second AP 104 (the target AP for the roam). In some embodiments, during the roaming transition phase 220, the client device 110 may be going back and forth between the links of the first AP 102 and the second AP 104. In yet another embodiment, during the roaming transition phase 220 the client device 110 may be connected to both the first AP 102 and the second AP 104 simultaneously (e.g., if the client device is a multi-radio device).

In the roaming transition phase 220, the client device 110 can fetch buffered DL data from the first AP 102. However, the client device 110 faces a timing challenge in determining when to complete its transition to the second AP 104 and initiate UL and DL transmissions with the second AP 104. Without buffer status information from the first AP 102, the client device 110 must rely on a data delivery timeout, which may be a longer timeout than necessary, resulting in the client device 110 unnecessarily waiting and adding delay to the roaming transition.

To address this problem, the first AP 102 can send buffer indication signaling (shown as transmission 225 in FIG. 2) as part of the roaming transition phase 220 to indicate when the first AP 102 has delivered all or substantially all of its queued data for the client device 110. The buffer indication signaling enables the client device 110 to make informed decisions about when to complete its transition based on actual DL data buffer conditions rather than conservative timeout values. Once the client device 110 determines there is no buffered DL data (or only a threshold amount remains) to receive in response to the signaling from the first AP 102, the client device 110 can complete the roaming transition and delete all links with the first AP 102, enabling the client device 110 to begin UL and DL transmissions with the second AP 104 without unnecessary delay.

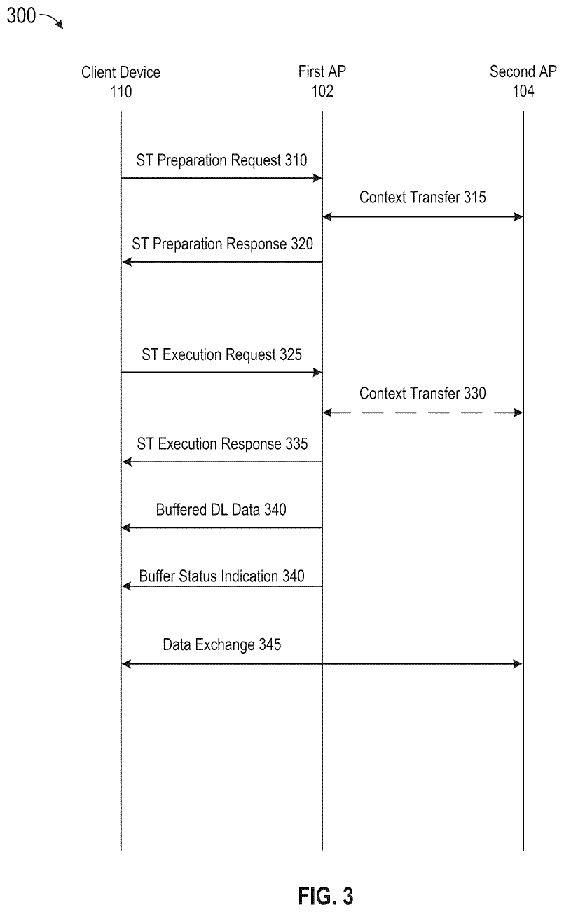

FIG. 3 is a message exchange diagram illustrating a procedure 300 for client signaling to target APs for seamless roaming. The illustrated procedure 300 shows communications between the client device 110, the first AP 102 (serving AP), and the second AP 104 (target AP) during a seamless roaming process that incorporates the buffer indication signaling mechanisms described herein.

At some point prior to the message exchanges illustrated in FIG. 3, the client device 110 may determine to initiate a seamless roaming process. Initiating a seamless roaming process by the client device 110 may be triggered upon receiving a report from the first AP 102. Such report may be generated based on observed network conditions and parameters associated with the quality of connection of the client device 110 with the first AP 102 and/or other APs that are available. Alternatively, the client device 110 may determine to initiate seamless roaming based on RSSI measurements, trajectory predictions, BSS load, or other factors. Upon making this determination, the client device 110 may optionally perform initial signaling exchange with the first AP 102, such as requesting a Neighbor Report from the first AP 102 that includes identification of several available target APs.

Once the client device 110 determines to initiate seamless roaming, the client device 110 sends an ST preparation request to the first AP 102 in stage 310. The ST preparation request may be implemented as a UHR Link Reconfiguration Request frame or another signaling frame. For example, the UHR Link Reconfiguration Request may include one or more Reconfiguration ML elements indicating links to be added or setup with one or more candidate target AP MLDs along with (optionally) a preference order of desired candidates. The ST preparation request may further include other roaming related indication and parameters such as a preparation indication, a Roaming SN, a context transfer indication indicating the set of contexts to be transferred, a resource reservation request, a context negotiation request, and/or other roaming context information.

After receiving the ST preparation request in stage 310, the first AP 102 may determine a final list of candidate target APs. This list may include the second AP 104 and potentially other target APs. Once the list is determined, the first AP 102 performs context transfer in exchange 315 with the candidate target APs (including the second AP 104) to transfer one or more roaming context parameters and reserve resources on the candidate target APs, and/or to perform negotiation of one or more roaming context parameters with the candidate target APs and to setup link(s) with the candidate target APs.

The roaming preparation and context transfer may include transfer of near static context (or any selected context information) to one or more candidate target APs for roaming in the future, pre-setting up of links on one or more candidate target APs (with the links not yet activated and 802.1x port not yet open for data transfer), and optional resource reservation for one or more resources on the candidate target APs for a time period (such as a Roaming Execution Timer duration). The resources reserved may include pre-assignment of setup links for the client device 110, reserving QoS resources for one or more SCS streams as requested by the client device 110 or selected by the first AP 102, reserving resources for TWT agreements (either existing TWT agreements that are requested to be transferred to specific links or new TWT agreements that are requested to be negotiated), reserving Block Acknowledgment resources, and/or reserving any other resources requested by the client device 110 or selected by the first AP 102. The context transferred may include parameters related to block acknowledgement agreements setup for the client device 110, SCS streams setup for the client device 110, MSCS streams setup for the client device 110, TWT agreements setup for the client device 110, TTLM agreements setup for the client device 110, security association context associated with the client device 110, capabilities of the client device 110, and/or other context information. The static context to be transferred to candidate target APs may be specified by the client device 110 and the first AP 102 (negotiated between them).

Following the context transfer in exchange 315, the first AP 102 sends an ST preparation response to the client device 110 in stage 320. The ST preparation response may include an indication of one or more candidate target APs (such as a list of candidate target APs that may be listed in preference order) that are prepared for roaming, an indication of a set of one or more static context parameters that were transferred to the candidate target APs, an indication of one or more context parameters that were negotiated with the candidate target APs, an indication of resources reserved at the candidate target APs (e.g., links that are added with the target APs), an Association Identifier (AID) assigned to the client device 110, and/or a Roaming Allowance Duration (RAD) or Roaming Execution Timer value.

In embodiments where a UHR Link Reconfiguration Request is used for roaming preparation, a corresponding UHR Link Reconfiguration Response may include ML element(s) (e.g., Basic Multi-link element or Reconfiguration ML element) for one or more target APs that are prepared and roaming context information that includes one or more of status (e.g., accept/reject) for roaming preparation, a roaming preparation indication, a Roaming SN, context transfer indication that indicates the set of context that were transferred, context negotiation indication that indicates one or more context parameters that were negotiated with the candidate target APs, resource reservation indication indicating the set of resources reserved, RAD/Roaming Execution Timer, and/or other information. The Roaming SN may be used to tie the roaming preparation phase with a subsequent roaming execution phase. If at least one candidate target AP (the second AP 104 in the illustrated embodiment) accepts the ST preparation request, the preparation phase is considered successful. Once the ST preparation response is received by the client device 110, the roaming preparation phase may be considered complete.

Thereafter, the client device 110 may determine a target AP to roam to from among the list of candidate target APs that are prepared for SMD roaming using exchanges described in stage 310 and stage 320. For example, the client device 110 may select the second AP 104 as the target AP to roam to. This determination may be based on RSSI measurements, location and trajectory information, channel load observations, preference order provided in the ST preparation response, and/or other factors. Once the client device 110 determines the target AP, the roaming execution phase may be triggered when the client device 110 sends an ST execution request to the first AP 102 in stage 325.

Using the ST execution request, the client device 110 may send a roaming execution request (e.g., an Add Link Request, a UHR Link Reconfiguration Request, etc.) to the first AP 102 to request roaming execution to the selected target AP (the second AP 104). The ST execution request may include roaming context information that includes one or more of a field for execution indication, a Roaming SN to tie the roaming execution phase with the roaming preparation phase, a context transfer indication indicating set of (dynamic) context to be transferred, context negotiation indication that indicates one or more context parameters to negotiate with the target AP, and/or other information.

After the first AP 102 receives the ST execution request in stage 325, optional context transfer in exchange 330 may take place between the first AP 102 and the target AP (the second AP 104). This exchange may be performed according to any known or to be developed signaling procedure whereby the first AP 102 confirms the roaming with the selected target AP and exchanges dynamic context (e.g., SN and/or Packet Number (PN)) with the selected target AP. During the dynamic context transfer, in parallel, the target AP (the second AP 104) may initiate a Distribution System (DS) mapping change to switch the data path for the client device 110 from the first AP 102 to the second AP 104. The DS mapping change may be completed via signaling exchange between the second AP 104 and the DS, enabling the network to route data traffic for the client device 110 to the second AP 104 rather than the first AP 102.

The first AP 102 sends an ST execution response in stage 335 to the client device 110 to confirm that roaming execution and dynamic context transfer as part of that process is complete. The ST execution response may be implemented as an Add Link Response, a UHR Link Reconfiguration Response, or other signaling frame. The ST execution response may include roaming context information such as information indicating status of the roaming execution (e.g., accept/reject), an execution phase indication, a Roaming SN, a context transfer indication indicating set of context that were transferred to the target AP, Group Keys of the links setup with the target AP, and/or other information.

Following the ST execution response in stage 335, the first AP 102 may optionally cancel resources reserved on other candidate target APs (which occurred along with static context transfer during the context transfer in exchange 315). Alternatively, the resource reservation (and links setup) on other candidate target APs can expire automatically (e.g., upon expiration of a timer which may be the same or different than the RAD).

Before and/or after transmitting the ST execution response in stage 335, the first AP 102 can send buffered DL data to the client device 110 in stage 340. The first AP 102 may be allowed to transmit buffered DL data to the client device 110 for a buffered DL data drain period, during which the client device 110 and the first AP 102 operate in DL data draining mode. During this DL data draining mode, the client device 110 faces a timing challenge in determining when to complete its transition to the second AP 104. Without buffer status information from the first AP 102, the client device 110 may be required to rely on a data delivery timeout (also referred to as a data drain timeout or DL data drain timeout). To address this problem, once all or substantially all of the buffered DL data has been transmitted to the client device 110, the first AP 102 sends a buffer status indication in stage 340 to indicate when the first AP 102 has delivered all or substantially all of its buffered data for the client device 110. The buffer status indication enables the client device 110 to make informed decisions about when to complete its transition based on actual DL data buffer conditions rather than conservative timeout values.

In certain embodiments, the buffer status indication comprises an empty buffer indication signaling that the first AP 102 has no remaining buffered DL data (or only a threshold amount remains) for the client device 110. The empty buffer indication may be sent on one of the active links where the first AP 102 was delivering the buffered DL data. Various approaches may be used to signal the empty buffer indication, including using a Queue Size field in the QoS Control field of a QoS data frame to signal zero buffered traffic for a TID, using an AP PS Buffer State field in the QoS Control field to signal empty buffer status, using a BSR control field in an A-Control field of a DL MPDU to provide buffer status indication, using a Link Reconfiguration Notify frame, and/or using a newly defined A-Control field to provide an empty buffer indication from the serving AP. In some embodiments, the buffer status indication may also indicate remaining buffer size (non-zero) to assist the client device 110 in determining whether to wait for additional data or transition to the target AP based on factors such as the amount of remaining buffered data, RSSI with the first AP 102, and current modulation and coding scheme (MCS) being used.

In other embodiments, the buffer status indication comprises signaling to delete the links with the first AP 102, wherein the deletion of links implicitly signals that the first AP 102 has completed delivery of buffered DL data. When the first AP 102 has completed delivery of all or substantially all buffered DL data (e.g., across TIDs/ACs), the first AP 102 can send a management frame or action frame to signal deletion of links for the client device 110. The management frame may be sent as soon as possible to minimize the amount of time the client device 110 waits unnecessarily for receiving DL buffered data when there is no buffered data left. The management frame may be implemented as a Link Reconfiguration Notify frame with a Reconfiguration ML element that indicates delete link operation for the links with the first AP 102, a Link Reconfiguration Request frame to signal deletion of all links with the first AP 102, a BTM Request frame that includes a Reconfiguration ML element in a Neighbor Report element signaling deletion of links, or another management frame. In some implementations, the management frame may include a specific reason code or field indicating a reason for deleting the links (e.g., “serving AP done with delivery of buffered DL data”). The deletion of client links with the first AP 102 may be triggered and performed by the first AP 102 itself (instead of the client device 110) to optimize the process and reduce overhead.

In some embodiments, the first AP 102 may perform empty buffer indication signaling initially and then perform delete link signaling after the first AP 102 has a high confidence level (such as over 95% certain) that no additional delayed data will appear. This approach accounts for the possibility of long-delayed data (e.g., MSDUs) reaching the first AP 102 from the network after the first AP 102 has sent the buffer status indication to the client device 110. If such delayed data arrives after the empty buffer indication but before link deletion, the first AP 102 may silently attempt to forward the new MSDUs to the second AP 104 without disclosing their existence to the client device 110 and/or aggressively attempt to transmit an updated buffer indication to the client device 110. For example, the first AP 102 can transmit signaling indicating non-empty buffers, or if the client device 110 is in a power save mode (PM=1), the first AP 102 may indicate via the TIM element that the first AP 102 has buffered traffic for the client device 110. Alternatively, if the first AP 102 is able to forward any delayed data to the second AP 104, the first AP 102 may directly use delete link signaling without requiring initial empty buffer indication signaling.

After receiving the buffer status indication in stage 340, the client device 110 can determine that there is no buffered DL data (or only a threshold amount remains) to receive from the first AP 102, enabling the client device 110 to promptly complete the roaming transition and delete all links with the first AP 102 without waiting for the full data delivery timeout period to expire. The client device 110 can then exchange data with the second AP 104 in stage 345, beginning UL and DL transmissions with the second AP 104 at the optimal time—neither waiting unnecessarily for a conservative timeout nor transitioning prematurely before all buffered data has been retrieved. This buffer indication signaling mechanism results in faster roaming transition times, reduced latency, and improved overall user experience during seamless roaming operations.

### Empty Buffer Indication

FIG. 4 illustrates an example QoS data frame 400 with a QoS control field 410 in the MAC header that can be used by the first AP 102 to provide buffer indication signaling to the client device 110 during seamless roaming transitions. The QoS control field 410 includes a Queue Size field 415 that APs can use to signal to the client device 110 buffer status information for the TID indicated in the QoS Control field 410.

The Queue Size field 415 is typically used by non-AP STAs to report their buffer status to APs. To enable buffer indication signaling, the Queue Size field 415 rules are modified to allow APs to send the Queue Size field 415 in QoS data frames (of any subtype or a subset of QoS frame subtypes) to signal buffer status information to client devices during seamless roaming transitions. This enables the serving AP (e.g., the first AP 102) to provide the client device 110 with information about remaining buffered DL data, so the client device 110 knows when the serving AP has completed delivery of buffered data and when to complete its transition to the target AP.

In certain embodiments, the serving AP can set the Queue Size field 415 to zero to signal zero buffered traffic for the TID specified in the QoS Control field 410 in the last MPDU sent to the client device 110 for that TID. This empty buffer indication informs the client device 110 that no additional buffered data remains for that TID, enabling the client device 110 to make informed decisions about when to complete its roaming transition to the target AP without waiting for a conservative data delivery timeout to expire.

In other embodiments, the serving AP can use the Queue Size field 415 to signal to the client device 110 how much remaining buffered data it has in the TID buffer for the TID specified, using the same rules as used by non-AP STAs per baseline specifications or with enhancements in terms of how to signal the buffered traffic. This helps the client device 110 to determine when to fully transition its radio resources to the target AP based on the actual amount of remaining buffered data. For example, the client device 110 can use the information in the queue size field 415 along with its RSSI measurements and current MCS with the serving AP to decide whether it should wait to receive more data or transition fully to the target AP. If the client device 110 determines that the remaining buffer size is small and the RSSI with the serving AP is poor (resulting in low data rate MCS), the client device 110 may decide to transition to the target AP even before completing retrieval of all remaining buffered data from the serving AP. Conversely, if the remaining buffer size is significant for a high-priority TID (e.g., TID 6 or TID 7) and the RSSI with the serving AP is good, the client device 110 may decide to continue fetching the buffered data before transitioning.

In certain embodiments, the serving AP can send the Queue Size field 415 in the QoS Control field 410 to report non-zero buffered data with precise or approximate values in only the last few MPDUs sent to the client device 110 for optimization purposes. In other MPDUs for that TID earlier in the data delivery sequence, the serving AP can set the queue size field 415 to a value representing a buffer estimate, such as value 254 to signal buffer size greater than 64768 octets or value 255 to signal unspecified buffer size. This approach reduces overhead while still providing the client device 110 with sufficient information to make roaming decisions, with more precise buffer status information provided only as the buffer nears empty.

In some embodiments, the Queue Size field 415 can provide empty buffer indication for multiple TIDs simultaneously. For example, the eight-bit Queue Size field 415 can be reinterpreted as a bitmap to signal empty buffer indication for up to eight TIDs (e.g., TIDs 0-7). In this embodiment, the AP can set the corresponding bit to 1 to signal empty buffer for that TID. For example, Bit 0 is set to 1 to signal empty buffer for TID 0, Bit 1 is set to 1 to signal empty buffer for TID 1, and so on. This bitmap approach enables the serving AP to provide comprehensive buffer status information across multiple TIDs in a single field, enabling the client device 110 to determine whether any buffered data remains across any TID before completing its roaming transition.

FIG. 5 illustrates another example QoS data frame 500 with a QoS control field 410 in the MAC header that can be used by the first AP 102 to provide buffer indication signaling to the client device 110 during seamless roaming transitions. This QoS control field 410 includes an AP Power Save (PS) Buffer State field 505. The AP PS Buffer State field 505 rules are modified to allow the serving AP to use the AP PS Buffer State field 505 to signal buffer status information during roaming execution and roaming transition phases.

The AP PS Buffer State field 505 includes several subfields, including a Buffer State Indicated field, a Highest Priority Buffered Access Category (AC) field, and a QoS AP Buffered Load field. The serving AP can use these subfields in various ways to provide buffer indication signaling to the client device 110.

In example implementations, the serving AP sets the QoS AP Buffered Load field of the AP PS Buffer State field 505 to indicate when zero buffer for the AC indicated by the Highest Priority Buffered AC field. This provides an indication that the serving AP has no remaining buffered data for the specified AC.

In further implementations, the serving AP can set the Highest Priority Buffered AC field to one of the ACs corresponding to the TID indicated in the MPDU, and then indicate buffer size (including zero buffer) for that AC or for that TID in the QoS AP Buffered Load field. This approach enables the serving AP to signal both non-zero and zero buffer status for specific TIDs or ACs, providing the client device 110 with information to make informed roaming transition decisions.

In further embodiments, the serving AP can use the reserved bit in the AP PS Buffer State field 505 to signal an empty buffer indication across all TIDs at the serving AP. For example, the serving AP can set an empty buffer indication bit to 1 to signal that no buffered data remains for any TID. This provides a comprehensive indication that enables the client device 110 to immediately complete its roaming transition without waiting for a conservative data delivery timeout to expire. Alternatively, the serving AP can use the reserved bit or another bit to signal empty buffer status specifically for the TID indicated in the QoS Control field 410, providing TID-specific buffer status information.

In some embodiments, the AP PS Buffer State field 505 can be used in a similar manner as the Queue Size field 415 to signal queue size at the serving AP for the TID indicated in the QoS Control field 410. The AP PS Buffer State field 505 can be defined to have a Scaling Factor (SF) similar to the Queue Size field 415, enabling the serving AP to signal queue size values with appropriate scaling. In this way, the serving AP can signal both non-zero and zero buffer status for a specific TID in this field. To indicate empty queue size, the field is set to a specific value (e.g., 0). This approach provides the client device 110 with precise buffer status information that can be used along with other factors (such as RSSI measurements and current MCS with the serving AP) to determine the optimal time to complete the roaming transition to the target AP.

In certain embodiments, the AP PS Buffer State field 505 is used as a bitmap that signals empty buffer status for each TID. In this bitmap embodiment, each bit indicates empty buffer for the corresponding TID. For example, when a bit is set to 1, it indicates empty buffer for the corresponding TID (e.g., bit 0 indicates empty buffer for TID 0, bit 1 indicates empty buffer for TID 1, and so on). This bitmap approach enables the serving AP to provide comprehensive buffer status information across multiple TIDs in a single field, similar to the bitmap embodiment described with respect to FIG. 4, enabling the client device 110 to determine whether any buffered data remains across any TID before completing its roaming transition.

By providing buffer status information through the AP PS Buffer State field 505, the serving AP enables the client device 110 to make informed decisions about when to complete its transition to the target AP based on actual DL data buffer conditions rather than conservative timeout values, resulting in faster roaming transition times, reduced latency, and improved overall user experience during seamless roaming operations.

FIG. 6 is a block diagram of a BSR control field 600 that can be used by the first AP 102 to provide buffer indication signaling to the client device 110 during seamless roaming transitions. The BSR control field 600 is provided to the client device 110 as part of a DL transmission (e.g., MPDU) and enables the serving AP to inform the client device 110 about buffer status at the serving AP. In baseline IEEE 802.11 specifications, the BSR A-Control field is typically used by non-AP STAs to report their buffer status to APs. The present disclosure expands the existing rules to allow APs to send the BSR control field 600 in DL MPDUs to signal buffer status information to client devices during seamless roaming transitions. The BSR control field 600 may be carried within an A-Control field or may itself be a BSR A-Control field in various embodiments.

The BSR control field 600 includes several subfields, including an AC Identifier (ACI) Bitmap 610, a Delta TID field 612, an ACI High field 614, a Scaling Factor field 616, a Queue Size High field 618, and a Queue Size All field 620. These subfields can be used in various ways to provide buffer status information to the client device 110. To optimize BSR reporting overhead, the serving AP may send the BSR control field 600 (or A-Control field) only in a small amount of the final DL MPDUs or only in the last DL MPDU delivered during the roaming transition. This approach reduces overhead while still providing the client device 110 with critical buffer status information when it is most needed for roaming decision-making.

In one embodiment, the Queue Size All field 620 is set to zero to indicate zero remaining buffer at the serving AP for all TIDs/ACs. In this case, the ACI Bitmap 610 is set to 0 and the Delta TID field 612 is set to 3 to signal that buffer status for all TIDs are reported. This provides a comprehensive empty buffer indication that enables the client device 110 to immediately complete its roaming transition and roaming execution without waiting for a conservative data delivery timeout to expire.

In certain embodiments, the BSR control field 600 can provide buffer status indication on a per-TID or per-AC level, enabling more granular buffer status reporting. For example, the eight-bit Queue Size All field 620 can be redefined or otherwise utilized as an empty buffer indication field for per-TID level reporting, where each bit indicates whether the buffer for the respective TID is empty or not. In this bitmap embodiment, each bit corresponds to a particular TID, and when set (e.g., to 1), indicates an empty buffer for that TID. The Queue Size High field 618 in the BSR control field 600 can be used to indicate the queue size for the AC indicated by the ACI High field 614, providing additional buffer status information for specific ACs.

Other ways of repurposing bits in the BSR control field 600 to signal empty buffer indication or buffer status for specific TID/AC are possible in further embodiments. For example, various combinations of the subfields can be used to provide both comprehensive (all TIDs) and granular (per-TID or per-AC) buffer status information to accommodate different roaming scenarios and client device needs.

In another embodiment, a new A-Control field can be defined that provides empty buffer indication for the TIDs/ACs at the serving AP to the client device 110. For example, a new eight-bit empty buffer indication control field can be defined wherein each bit of the empty buffer indication control field can (e.g., when set to 1) indicate an empty buffer for a particular TID. In this embodiment, bit 0 indicates empty buffer for TID 0, bit 1 indicates empty buffer for TID 1, and so on. This dedicated empty buffer indication control field provides a clear and straightforward mechanism for signaling empty buffer status across multiple TIDs.

In one embodiment, the serving AP can provide both the BSR control field 600 and this new A-Control field in the same MPDU to signal buffer status for specific TIDs/ACs and also signal empty buffer status for certain other TIDs/ACs. This combined approach enables the serving AP to provide both quantitative buffer status information (e.g., remaining buffer size) for some TIDs and binary empty/non-empty status for other TIDs, giving the client device 110 comprehensive information for roaming decision-making. For example, the client device 110 can use remaining buffer size information along with its RSSI measurements and current MCS with the serving AP to decide whether it should wait to receive more data or transition fully to the target AP.

FIG. 7 is a block diagram of an example UHR Link Reconfiguration Notify frame 700 that can be used by the first AP 102 to provide buffer indication signaling to the client device 110 during seamless roaming transitions. The UHR Link Reconfiguration Notify frame 700 is a management frame that enables the serving AP to notify the client device 110 whether the serving AP has any remaining buffered data for the client device 110, either across all TIDs or on a per-TID basis.

The UHR Link Reconfiguration Notify frame 700 includes a DL Data Drain info field 710 with subfields to indicate when DL draining is completed across all TIDs or per-TID. The DL Data Drain info field 710 includes an All TIDs Info field that indicates whether DL data draining is completed for all TIDs. If DL data draining is not completed for all TIDs, the DL Data Drain info field 710 can include a Per-TID Info Set field 715 that provides per-TID information about DL data draining status.

The Per-TID Info Set field 715 includes a TID field that identifies the specific TID for which information is being provided, a TID DL Draining Completed field that indicates whether DL data draining is completed for that TID, a Queue Size Present field 720 that indicates the presence of a Queue Size field 725, and the Queue Size field 725 that indicates the remaining buffer size for the TID at the serving AP MLD.

The serving AP can send the UHR Link Reconfiguration Notify frame 700 to the client device 110 to provide an empty buffer indication and/or remaining buffer size information for per-TID basis. The TID DL Draining Completed field is set to a first value (e.g., 1) when there is no more buffered DL traffic for the TID specified in the TID field and set to a second value (e.g., 0) otherwise. When the TID DL Draining Completed field indicates that draining is not completed (e.g., set to 0), the Queue Size field 725 can be included in the Per-TID Info Set field 715 to provide the remaining buffer size for that TID at the serving AP MLD.

When the serving AP sends a buffer status indication regarding the amount of data remaining, such as via the QoS data frames 400, 500 (described with respect to FIGS. 4-5), the BSR control field 600, a UHR Link Reconfiguration Notify frame 700, or a control field (e.g., an A-Control field, an empty buffer indication control field, etc.), the serving AP also signals via the TIM element that the serving AP has no buffered traffic for the client device 110 when all TID buffers are zero/empty. This TIM signaling follows baseline IEEE 802.11 behavior and provides an additional mechanism for the client device 110 to be informed of empty buffer status, particularly when the client device 110 is in power save mode.

In implementations where the empty buffer state changes after the empty buffer indication is sent to the client device 110 (e.g., long-delayed MSDUs reach the serving AP from the network after the serving AP has sent the zero/empty buffer indication to the client device 110), the serving AP may handle the situation in various ways. In one approach, the serving AP silently attempts to forward the new data to the target AP without informing the client device 110. This approach avoids requiring the client device 110 to return to the serving AP for additional data delivery after the client device 110 has already begun transitioning to the target AP. In another approach, the serving AP attempts to transmit an updated buffer indication to the client device 110. For example, the serving AP can transmit the signaling described above for indicating non-empty buffers. Alternatively, if the client device 110 is in power save mode (PM=1), the serving AP can indicate via the TIM element that the serving AP has buffered traffic for the client device 110.

By providing buffer status information through the BSR control field 600, the serving AP enables the client device 110 to make informed decisions about when to complete its transition to the target AP based on actual DL data buffer conditions rather than conservative timeout values, resulting in faster roaming transition times, reduced latency, and improved overall user experience during seamless roaming operations.

### Delete Links Indication

In some embodiments, instead of or in addition to providing an empty buffer indication (such as via the operations and frames described above with respect to FIGS. 4-7), the serving AP MLD signals that it is done with delivering buffered DL data to the client device 110 during roaming transition by signaling delete links indications (e.g., explicit delete links for the set of links with the serving AP). When the serving AP MLD has completed delivery of all or substantially all buffered DL data (e.g., across TIDs/ACs), it can send a management frame to signal deletion of links for the client device 110. The deletion of links implicitly signals that the serving AP has completed delivery of buffered DL data, enabling the client device 110 to determine that it should complete its transition to the target AP.

In some embodiments, the serving AP can send a Link Reconfiguration Notify frame (e.g., a UHR Link Reconfiguration Notify frame) to the client device 110 to provide the delete link indication. In example implementations, the Link Reconfiguration Notify frame includes a Reconfiguration ML element that indicates delete link operation for the links with the current serving AP. This signals to the client device 110 that the links are being deleted with the serving AP and no more buffered DL data will be delivered to the client device 110. Upon receiving this indication, the client device 110 can complete its roaming transition to the target AP, thereby fully establishing data exchanges with the target AP.

In certain embodiments, the serving AP MLD can send a Link Reconfiguration Request frame to the client device 110 to signal deletion of all links with the current serving AP for that client device 110. This signals to the client device 110 that the links are being deleted with the serving AP and no more buffered DL data will be delivered to the client device 110. The client device 110 may respond with a Link Reconfiguration Response frame to acknowledge the link deletion.

In further embodiments, the serving AP can send a BTM Request frame that includes a Reconfiguration ML element in the Neighbor Report element that signals deletion of links with the current AP, or includes a Basic ML element in the Neighbor Report element that does not include any links with the current AP (thereby signaling deletion of those links). The BTM Request frame provides an alternative mechanism for signaling link deletion using existing baseline IEEE 802.11 management frame structures.

For the embodiments described above, the deletion of client links with the serving AP MLD is triggered and performed by the serving AP MLD itself (instead of being initiated by the client device 110) to optimize the process and reduce overhead. This AP-initiated link deletion approach enables faster roaming transition completion because the serving AP can immediately signal completion of buffered data delivery without waiting for the client device 110 to independently determine when to delete the links. The serving AP has direct knowledge of its buffer status and can therefore make more timely and accurate determinations about when link deletion should occur.

In some embodiments, the serving AP may send the Link Reconfiguration Notify frame, the BTM Request frame, or another management frame with a specific reason code or field indicating a reason for deleting the links, such as “serving AP done with delivery of buffered DL data” or similar language. This specific reason code provides explicit information to the client device 110 about why the links are being deleted, distinguishing this deletion from other types of link deletion that may occur for different reasons (e.g., poor link quality, AP configuration changes, etc.). In the various frames described above, the reason of “serving AP done with delivery of buffered DL data” can be indicated using other fields instead of an explicit reason code field in example implementations (e.g., in the UHR Link Reconfiguration Notify frame this can be indicated using a specific Type field value which indicates that AP is done with delivery of buffered DL data). Upon receiving the management frame with this specific reason code, the client device 110 understands that the link deletion is due to completion of buffered data delivery and can respond accordingly by deleting its links with the serving AP MLD, for example using Link Reconfiguration Request/Response frames or by locally deleting the links without additional signaling with the serving AP.

In certain implementations, the serving AP may handle delayed MSDUs that arrive after signaling link deletion in various ways. Because the serving AP may be unable to continue sending data to the client device 110 once the links are deleted, this makes it difficult to deliver such delayed data via the serving AP. To address this situation, the serving AP might perform empty buffer indication signaling initially (e.g., using the approaches described with respect to FIGS. 4-7) and then perform the delete link signaling only after the serving AP has a high confidence level (such as over 95% certain, or over 99% certain) that no such delayed data will appear. This staged approach accounts for the possibility of long-delayed data (e.g., MSDUs) reaching the serving AP from the network after the serving AP has sent the empty buffer indication to the client device 110, but before links have been deleted.

Alternatively, if the serving AP is able to forward any delayed data to the target AP, the serving AP may directly use delete link signaling without requiring initial empty buffer indication signaling. In this approach, if long-delayed MSDUs reach the serving AP from the network after the serving AP has sent the delete link indication to the client device 110, the serving AP can forward the new MSDUs to the target AP without notifying the client device 110. This maintains the seamless roaming experience for the client device 110 while ensuring that no data is lost, as the data is delivered via the target AP rather than requiring the client device 110 to return to the serving AP.

By providing delete links indication as a mechanism for buffer status signaling, the serving AP enables the client device 110 to make informed decisions about when to complete its transition to the target AP based on actual DL data buffer conditions rather than conservative timeout values, resulting in faster roaming transition times, reduced latency, and improved overall user experience during seamless roaming operations.

### Methods

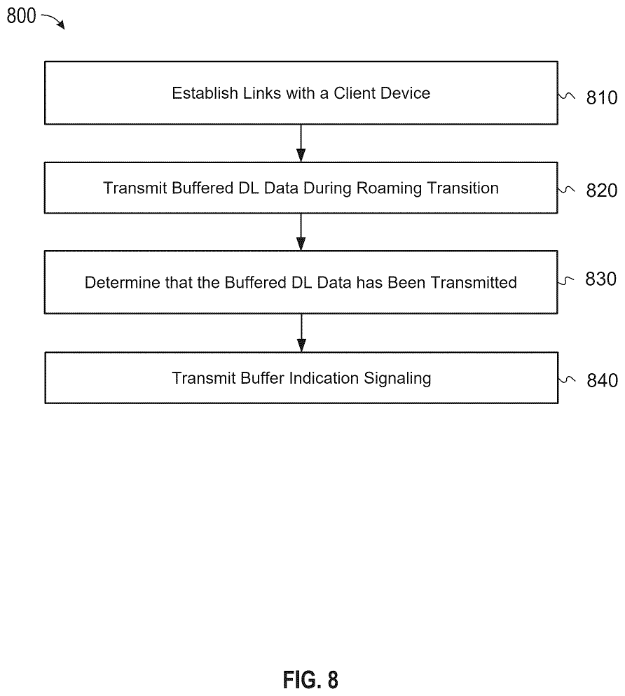

FIG. 8 is a flowchart illustrating a method 800 for buffer indication signaling for seamless roaming. The method 800 may be performed by a serving AP (e.g., the first AP 102) to enable a client device (e.g., the client device 110) to determine when to complete a transition and roaming execution to a target AP (e.g., the second AP 104) based on actual DL data buffer conditions at the serving AP.

At stage 810, the serving AP establishes one or more links with the client device. The client device is configured to roam from the serving AP to the target AP, and both the serving AP and the target AP may be within a same SMD, enabling seamless roaming between them without the client device needing to disconnect, re-authenticate, re-associate, or experience packet loss. The one or more links may include multiple links established at different frequencies (e.g., 2.4 GHz, 5 GHz, 6 GHz) to enable multi-link communication between the serving AP and the client device. The establishment of the one or more links may occur during an initial association procedure or during a roaming preparation phase of a previous roaming transition.

At stage 820, the serving AP transmits buffered DL data to the client device during a roaming transition from the serving AP to the target AP. The roaming transition may be triggered by various factors, including RSSI measurements, trajectory predictions, network recommendations, or other factors indicating that the client device should roam to a different AP. During the roaming procedure, the client device may add or establish one or more links with the target AP (e.g., as part of roaming preparation) and perform roaming execution to the target AP. The roaming transition phase may start after roaming execution when the serving AP transmits buffered DL data to the client device. During the roaming transition, the client device may be waiting for the serving AP to finish transmitting buffered DL data before it can fully transition to the target AP.

At stage 830, the serving AP determines that the buffered DL data for the client device has been transmitted to the client device. In some embodiments, the serving AP determines that all buffered DL data has been transmitted to the client device, meaning that no buffered data remains at the serving AP for the client device across any TID or AC. In other embodiments, the serving AP determines that substantially all buffered DL data has been transmitted to the client device, meaning that only a threshold amount of buffered data remains at the serving AP. The threshold amount may be defined in various ways, such as a specific number of octets, a percentage of total buffered data, or a threshold that depends on TID priority (e.g., allowing more remaining buffered data for low-priority TIDs than for high-priority TIDs). The determination can also be based on per TID or per AC, meaning the serving AP can determine whether buffered DL data for certain TIDs or ACs have been delivered.

The determination at stage 830 may be made by the serving AP monitoring its buffer status for the client device across all TIDs or ACs. The serving AP may track the amount of buffered data remaining in each TID buffer and determine when each TID buffer becomes empty or substantially empty. Once the serving AP determines that the buffered DL data has been transmitted, the serving AP can proceed to stage 840 to transmit buffer indication signaling to the client device.

At stage 840, the serving AP transmits buffer indication signaling to the client device indicating that the serving AP has delivered the buffered DL data for the client device. The buffer indication signaling enables the client device to determine when to complete its transition to the target AP based on actual DL data buffer conditions at the serving AP rather than a conservative data delivery timeout value, resulting in faster roaming transition times, reduced latency, and improved overall user experience.

The buffer indication signaling at stage 840 may be implemented using various mechanisms and frame types depending on the embodiment. In certain embodiments, the buffer indication signaling comprises an empty buffer indication transmitted in a QoS data frame. The QoS data frame includes a QoS Control field having a Queue Size field, and the Queue Size field is set to indicate that the serving AP has delivered the buffered DL data. In some embodiments, the Queue Size field comprises a bitmap to signal empty buffer indication for a plurality of TIDs, wherein each bit of the bitmap corresponds to a respective TID of the plurality of TIDs and indicates empty buffer status when set to a first value.

In other embodiments, the buffer indication signaling comprises an empty buffer indication transmitted in a QoS data frame having a QoS Control field that includes an AP PS Buffer State field, wherein the AP PS Buffer State field is configured to indicate that the serving AP has delivered the buffered DL data. In further embodiments, the buffer indication signaling comprises a BSR control field set to indicate that the serving AP has delivered the buffered DL data. In some embodiments, the buffer indication signaling comprises a management frame (or action frame) transmitted by the serving AP to the client device where the frame indicates that the serving AP is done with the delivery of buffered DL data. In yet other embodiments, the buffer indication signaling comprises a management frame transmitted by the serving AP to the client device, wherein the management frame signals deletion of the one or more links between the serving AP and the client device. The deletion of the one or more links implicitly signals that the serving AP has completed delivery of buffered DL data, enabling the client device to determine that it should complete its transition to the target AP. In certain embodiments using the management frame approach, the management frame includes a Reason Code indicating that the serving AP has delivered the buffered DL data.

### Systems

FIG. 9 is a block diagram of a computing device 900. As shown in FIG. 9, computing device 900 may include a processing unit 910 and a memory unit 915. Memory unit 915 may include a software module 920 and a database 925. While executing on processing unit 910, software module 920 may perform, for example, processes for providing buffer indication signaling for seamless roaming. Computing device 900, for example, may provide an operating environment for the first AP 102, the second AP 104, the SMD-ME 108, the client device 110, the controller 120, and the like. The first AP 102, the second AP 104, the SMD-ME 108, the client device 110, the controller 120, and the like may operate in other environments and are not limited to computing device 900.

Computing device 900 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 900 may comprise any computer operating environment, such as hand-held devices, multiprocessor systems, microprocessor-based or programmable sender electronic devices, minicomputers, mainframe computers, and the like. Computing device 900 may also be practiced in distributed computing environments where tasks are performed by remote processing devices. The aforementioned systems and devices are examples, and computing device 900 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on, or read from, other types of computer-readable media, such as secondary storage devices, like hard disks, floppy disks, or a CD-ROM, a carrier wave from the Internet, or other forms of RAM or ROM. Further, the disclosed methods'stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a SOC where each or many of the elements illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure may be performed via application-specific logic integrated with other components of computing device 900 on the single integrated circuit (chip).

FIG. 10 illustrates an implementation of a communications device 1000 that may implement one or more of the first AP 102, the second AP 104, the SMD-ME 108, the client device 110, the controller 120, etc. In various implementations, the communications device 1000 may comprise a logic circuit. The logic circuit may include physical circuits to perform operations described for one or more of the first AP 102, the second AP 104, the SMD-ME 108, the client device 110, the controller 120, etc., for example. As shown in FIG. 10, the communications device 1000 may include one or more of, but is not limited to, a radio interface 1010, baseband circuitry 1030, and/or the computing device 900.

The communications device 1000 may implement some or all of the structures and/or operations for the first AP 102, the second AP 104, the SMD-ME 108, the client device 110, the controller 120, etc., storage medium, and logic circuit in a single computing entity, such as entirely within a single device. Alternatively, the communications device 1000 may distribute portions of the structure and/or operations using a distributed system architecture, such as a client station server architecture, a peer-to-peer architecture, a master-slave architecture, etc.

A radio interface 1010, which may also include an Analog Front End (AFE), may include a component or combination of components adapted for transmitting and/or receiving single-carrier or multi-carrier modulated signals (e.g., including Complementary Code Keying (CCK), Orthogonal Frequency Division Multiplexing (OFDM), and/or Single-Carrier Frequency Division Multiple Access (SC-FDMA) symbols), although the configurations are not limited to any specific interface or modulation scheme. The radio interface 1010 may include, for example, a receiver 1015 and/or a transmitter 1020. The radio interface 1010 may include bias controls, a crystal oscillator, and/or one or more antennas 1025. In additional or alternative configurations, the radio interface 1010 may use oscillators and/or one or more filters, as desired.

The baseband circuitry 1030 may communicate with the radio interface 1010 to process, receive, and/or transmit signals and may include, for example, an Analog-To-Digital Converter (ADC) for down converting received signals with a Digital-To-Analog Converter (DAC) 1035 for up converting signals for transmission. Further, the baseband circuitry 1030 may include a baseband or PHY layer processing circuit for the PHY link layer processing of respective receive/transmit signals. Baseband circuitry 1030 may include, for example, a MAC processing circuit 1040 for MAC/data link layer processing. Baseband circuitry 1030 may include a memory controller for communicating with MAC processing circuit 1040 and/or a computing device 900, for example, via one or more interfaces 1045.

In some configurations, PHY processing circuit may include a frame construction and/or detection module, in combination with additional circuitry such as a buffer memory, to construct and/or deconstruct communication frames. Alternatively or in addition, MAC processing circuit 1040 may share processing for certain of these functions or perform these processes independent of PHY processing circuit. In some configurations, MAC and PHY processing may be integrated into a single circuit.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

1. A method comprising:
establishing, by a serving access point (AP), one or more links with a client device, wherein the client device is configured to roam from the serving AP to a target AP;
transmitting, by the serving AP, buffered downlink (DL) data to the client device during a roaming transition from the serving AP to the target AP;
determining, by the serving AP, that the buffered DL data for the client device has been transmitted to the client device; and
transmitting, by the serving AP to the client device, buffer indication signaling indicating that the serving AP has delivered the buffered DL data for the client device.

2. The method of claim 1, wherein the buffer indication signaling comprises an empty buffer indication transmitted in a quality of service (QoS) data frame, wherein the QoS data frame includes a QoS control field having a queue size field, and wherein the queue size field is set to indicate that the serving AP has delivered the buffered DL data.

3. The method of claim 2, wherein the queue size field comprises a bitmap to signal empty buffer indication for a plurality of traffic identifiers (TIDs), wherein each bit of the bitmap corresponds to a respective TID of the plurality of TIDs and indicates empty buffer status when set to a first value.

4. The method of claim 1, wherein the buffer indication signaling comprises an empty buffer indication transmitted in a QoS data frame having a QoS control field that includes an AP power save (PS) buffer state field, wherein the AP PS buffer state field is configured to indicate that the serving AP has delivered the buffered DL data.

5. The method of claim 1, wherein the buffer indication signaling comprises a buffer status report (BSR) control field set to indicate that the serving AP has delivered the buffered DL data.

6. The method of claim 1, wherein the buffer indication signaling comprises a management frame transmitted by the serving AP to the client device, wherein the management frame that indicates that the serving AP has delivered the buffered DL data or signals deletion of the one or more links between the serving AP and the client device.

7. The method of claim 6, wherein the management frame includes a reason code indicating that the serving AP has delivered the buffered DL data.

8. A system comprising:
a memory storage; and
a processing unit coupled to the memory storage, wherein the processing unit is operative to:
establish one or more links with a client device, wherein the client device is configured to roam to a target AP;
transmit buffered downlink (DL) data to the client device during a roaming transition to the target AP;
determine that the buffered DL data for the client device has been transmitted to the client device; and
transmit, to the client device, buffer indication signaling indicating that the buffered DL data for the client device has been delivered.

9. The system of claim 8, wherein the buffer indication signaling comprises an empty buffer indication transmitted in a quality of service (QoS) data frame, wherein the QoS data frame includes a QoS control field having a queue size field, and wherein the queue size field is set to indicate that the buffered DL data has been delivered.

10. The system of claim 9, wherein the queue size field comprises a bitmap to signal empty buffer indication for a plurality of traffic identifiers (TIDs), wherein each bit of the bitmap corresponds to a respective TID of the plurality of TIDs and indicates empty buffer status when set to a first value.

11. The system of claim 8, wherein the buffer indication signaling comprises an empty buffer indication transmitted in a QoS data frame having a QoS control field that includes an AP power save (PS) buffer state field, wherein the AP PS buffer state field is configured to indicate that the buffered DL data has been delivered.

12. The system of claim 8, wherein the buffer indication signaling comprises a buffer status report (BSR) control field set to indicate that the buffered DL data has been delivered.

13. The system of claim 8, wherein the buffer indication signaling comprises a management frame that indicates that the serving AP has delivered the buffered DL data or signals deletion of the one or more links between the serving AP and the client device.

14. The system of claim 13, wherein the management frame includes a reason code indicating that the buffered DL data has been delivered.

15. A non-transitory computer-readable medium that stores a set of instructions which when executed perform a method comprising:
establishing one or more links with a client device, wherein the client device is configured to roam to a target AP;
transmitting buffered downlink (DL) data to the client device during a roaming transition to the target AP;
determining that the buffered DL data for the client device has been transmitted to the client device; and
transmitting, to the client device, buffer indication signaling indicating that the buffered DL data for the client device has been delivered.

16. The non-transitory computer-readable medium of claim 15, wherein the buffer indication signaling comprises an empty buffer indication transmitted in a quality of service (QoS) data frame, wherein the QoS data frame includes a QoS control field having a queue size field, and wherein the queue size field is set to indicate that the buffered DL data has been delivered.

17. The non-transitory computer-readable medium of claim 15, wherein the buffer indication signaling comprises an empty buffer indication transmitted in a QoS data frame having a QoS control field that includes an AP power save (PS) buffer state field, wherein the AP PS buffer state field is configured to indicate that the buffered DL data has been delivered.

18. The non-transitory computer-readable medium of claim 15, wherein the buffer indication signaling comprises a buffer status report (BSR) control field set to indicate that the buffered DL data has been delivered.

19. The non-transitory computer-readable medium of claim 15, wherein the buffer indication signaling comprises a management frame that indicates that the serving AP has delivered the buffered DL data or signals deletion of the one or more links between the serving AP and the client device.

20. The non-transitory computer-readable medium of claim 19, wherein the management frame includes a reason code indicating that the buffered DL data has been delivered.
